(19) United States
(12) Patent Application Publication
(10) Pub. No.: US 2007/0220879 A1
(43) Pub. Date: Sep. 27, 2007

(54) Pressure regulation in an automatic transmission

(76) Inventors: Ronald F. Lochocki JR., Ypsilanti, MI (US); Robert L. Moses, Ann Arbor, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/388,919

(22) Filed: Mar. 24, 2006

(51) Int. Cl. F16D 31/02

(52) U.S. Cl. 60/459

(57) ABSTRACT

A pressure regulating system for a power transmission includes a pressure regulating valve to issue a pressure signal to a load and also a pressure signal to a pressure transducer for feedback to a transmission control module (TCM) which in turn suggests the output pressure of the regulator valve to a desired level in accordance with a pressure command originally issued by the transmission control module. This system provides a closed-loop control for pressure regulation.

### TECHNICAL FIELD

This invention relates to electro-hydraulic controls for power transmissions and, more particularly, to pressure regulator valve controls in power transmissions.

### BACKGROUND OF THE INVENTION

Automatic shifting power transmissions include a hydraulic system, which supplies power to operate the various clutches and brakes and other elements within the transmission. The hydraulic pressure is limited or controlled in value to provide the most efficient operation that can be obtained.

In more recent transmissions, the hydraulic controls have been advanced to electro-hydraulic controls wherein electrical or electronic signals are available to assist in transmission controls. The electro-hydraulic controls generally comprise a solenoid valve, which receives various signals from a transmission control module (TCM) to supply a pressure signal to the various operating valves of the transmission. While these electro-hydraulic controls work quite well, there can be some improvement in the pressure regulation within the various systems of the power transmission.

### SUMMARY OF THE INVENTION

It is an object of this invention to provide an improved electro-hydraulic transmission control.

In one aspect of the present invention, the electro-hydraulic control solenoid supplies signals to a pressure regulator valve such that the proper output pressure is maintained.

In another aspect of the present invention, the pressure regulation valve supplies pressure to a load and a feedback of pressure to a hydraulic control module.

In yet another aspect of the present invention, the output pressure of a pressure regulator is subjected to or is operable on a pressure transducer, which issues an electronic signal to a transmission control module to effect control of a regulated pressure.

In still another aspect of the present invention, a pressure command is issued through a control algorithm to a solenoid valve which issues a pilot pressure through a pressure regulating valve; the output pressure of a pressure regulating valve is sensed by a pressure transducer which supplies a feedback signal to the transmission control module (TCM) to provide adjustment in the signal issued to the solenoid valve and therefore the output pressure of the regulator valve.

### DESCRIPTION OF THE DRAWINGS

FIG. 1 is a diagrammatic representation of an electro-hydraulic control system incorporating the present invention.

FIG. 2 is a schematic and diagrammatic representation of a portion of a hydraulic control system incorporating one embodiment of the present invention.

FIG. 3 is a schematic and diagrammatic representation of another embodiment of the present invention.

FIG. 4 is a schematic and diagrammatic representation of a further embodiment of the present invention.

### DESCRIPTION OF THE EXEMPLARY EMBODIMENTS

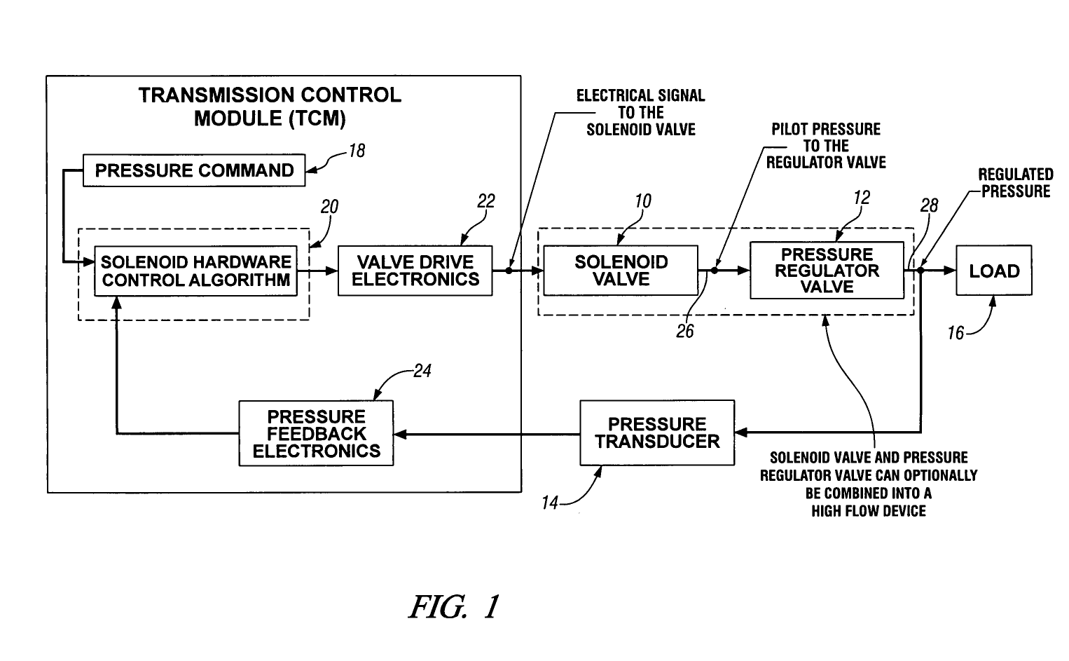

In FIG. 1, there is shown a diagrammatic representation of a portion of a transmission control system incorporating a transmission control module (TCM), a solenoid valve 10, a pressure regulator valve 12, a pressure transducer 14, and a transmission element 16. The transmission element 16 may be a conventional selectively operable torque-transmitting mechanism such as a clutch or brake for controlling the ratio within the transmission or, a torque converter clutch for controlling the efficiency of a torque converter or, the system hydraulic pressure, which hydraulically controls many aspects of the transmission operation.

The TCM includes a plurality of command signals such as throttle position, torque demand, vehicle speed, engine speed, and other characteristics or parameters of the powertrain. The pressure command is issued by a main transmission control 18 to the solenoid valve hardware control algorithm 20. The control algorithm 20 supplies output signals in electronic form to valve drive electronics 22. The TCM also includes some conventional electronics that provide feedback signals to the correction device 18.

The TCM also includes a conventional preprogrammable digital computer, which is the main operating base for the output signals. The valve drive electronics 22 issues signals to the solenoid valve 10, which in turn issues a pressure signal through a passage 26 to the pressure regulator valve 12 In an optional construction, the solenoid and regulator valve can be combined in a conventional high flow solenoid valve. The pressure regulator valve 12 provides an output pressure fluid in a passage 28, which is directed to the transmission element 16 and also to the pressure transducer 14. The pressure transducer 14 directs an electronic signal through the pressure feedback electronics 24 in the TCM. This provides a closed loop control regulator within the transmission control system.

The control algorithm 20 calculates an electronic signal in a conventional manner for the solenoid valve, which in turn provides the pilot pressure to the pressure regulation valve. The pressure regulation valve will respond to the pilot pressure to control the output pressure to the transmission element 16.

The pressure in passage 28 is also directed to the pressure transducer 14, which issues an electronic signal back through the TCM to the solenoid hydraulic control algorithm 20. If the signal received at error correction device 18 suggests that the output pressure of the regulator valve 12 is different from the pressure commanded in the transmission control module, a proper selection signal is generated in the control algorithm 20 to provide an output signal which will change the regulated pressure in passage 28 to a level commensurate or agreeable with the pressure commanded by the TCM.

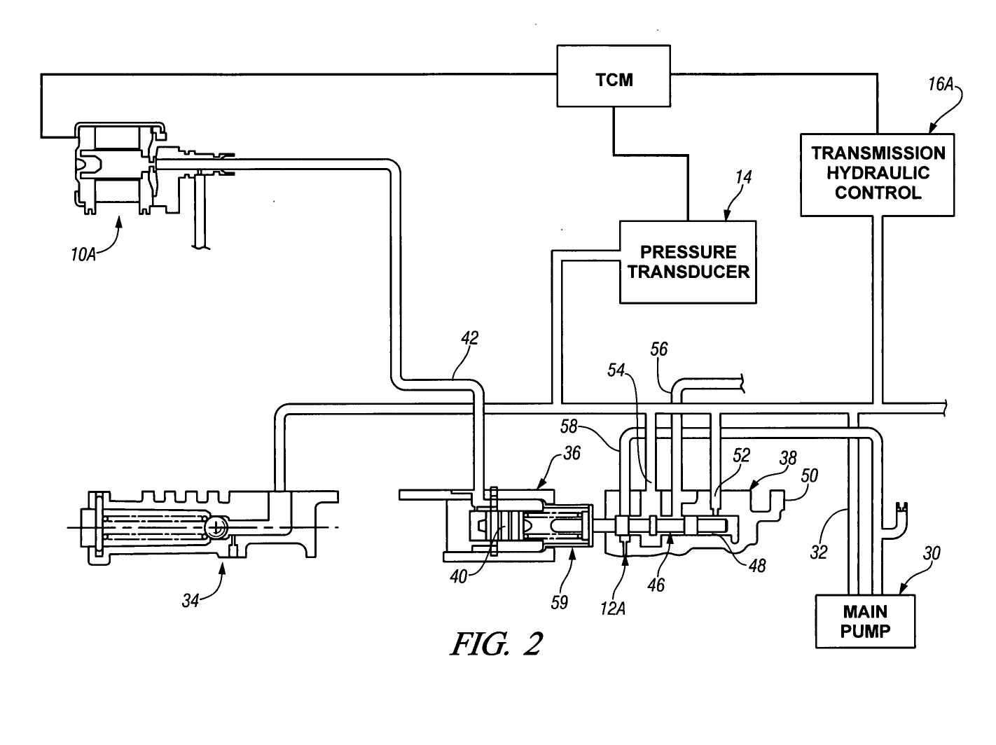

Referring to FIG. 2, there is seen a portion of a hydraulic control system for a transmission including a conventional hydraulic pump 30 which delivers fluid pressure to a main line passage 32. The line passage 32 is connected to a transmission element or hydraulic control 16A, which establishes a load on the pump 30 and therefore a pressure level within the hydraulic system. The main line 32 is connected with the pressure transducer 14, a pressure regulating valve 12A and a maximum pressure or blow-off valve 34. The blow-off valve 34 is a conventional pressure-regulating valve, which limits the maximum pressure within the system.

The regulating valve 12A includes a pilot portion 36 and a regulating valve portion 38. The pilot portion 36 includes a shuttle valve or plug valve 40, which is in fluid communication through a passage 42 with a solenoid control valve 10A. The solenoid control valve, as explained above with FIG. 1, receives signals from the TCM to establish the pressure level within the system. The shuttle valve or plug valve 40 operates through a spring 59 on the end of a valve spool 46, which is a portion of the regulator valve 38. The valve spool 46 is slidably disposed in a valve bore 48, which is part of a conventional valve body 50 or in the pump body. The valve body 50 has two ports 52 and 54, which admit line pressure to the valve bore 48 and a converter feed line or passage 56 and a return line or exhaust passage 58.

The spring 59 imposes a bias on the valve spool 46 such that the valve spool 46 is controlled and positioned to establish the pressure within the main line 32. The port 52 of the main line 32 operates on the right end of the valve spool 46 to balance the spring load established by the pilot valve 40. If the line pressure at passage 32 is greater than the line pressure commanded by the TCM through the solenoid 10A, the valve spool 46 will be urged leftward against the spring to exhaust excess fluid within the system through the passage 58.

The passage 56 supplies fluid pressure through a transmission control at which then directs the fluid to a conventional torque converter, not shown. The fluid in passage 54 is open to the pressure transducer 14 as well as to the control or transmission element 16A. The pressure in passage 54 causes the pressure transducer 14 to issue a signal to the TCM thereby assuring that the pressure in the passage 54 is commensurate with the pressure commanded by the TCM for proper operation of the transmission element 16A. The TCM, as previously explained, receives signals from various vehicle-operating mechanisms or sensors such as engine speed, drive position, vehicle speed, torque command, and other items. The TCM also receives signals from the transmission hydraulic control 16A to assure that the transmission is operating in the desired speed ratio or drive ratio established by the operator.

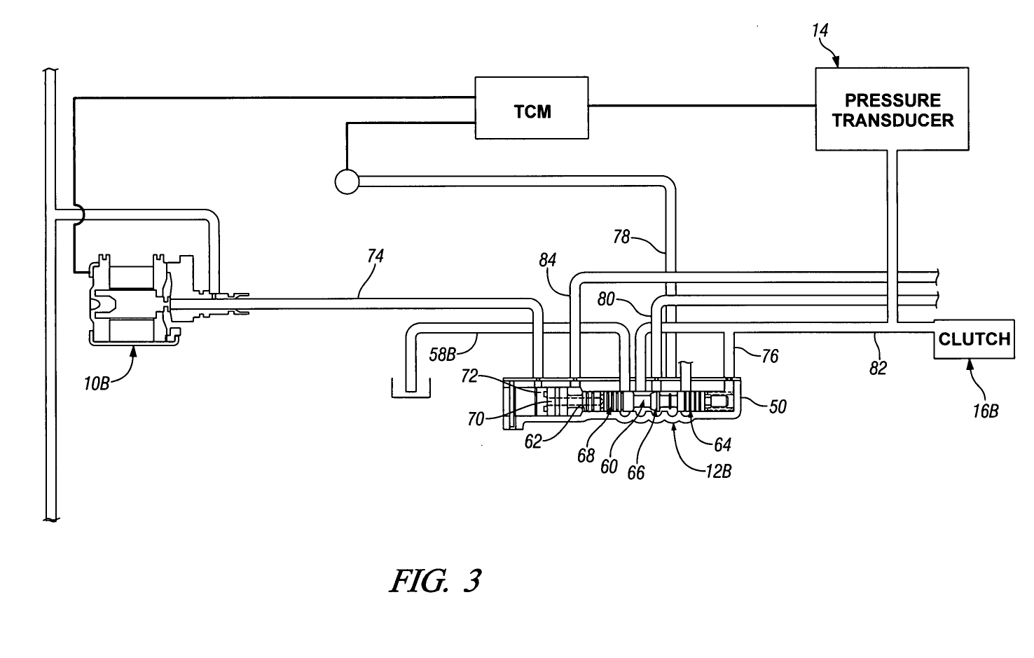

Referring to FIG. 3, there is seen a pressure regulator valve 12B, which includes a valve spool 60 slidably disposed in a valve bore 62 formed in the valve body 50. The valve spool 60 has three lands 64, 66, and 68 and a diameter land 70. The diameter land 70 cooperates with the left end of the valve bore 62 to form a pilot chamber 72. The pilot chamber 72 is connected with the solenoid valve 10B leading to a passage 74.

The valve bore 62 is also in fluid communication with a feed passage 80, a clutch apply passage 82, an optional passage 84, an exhaust passage 58B, and a feedback passage 76. The feedback passage 76 communicates with the clutch apply passage 82 to provide a signal to the right end of valve spool 60 to signal that the desired pressure is present at the transmission element 16B.

The passage 82 communicates with the transmission element 16B, which may be a torque-transmitting mechanism such as a clutch or a brake. The passage 82 also communicates with the pressure transducer 14 such that the actual pressure at the transmission element 16B can be communicated with the TCM. The fluid pressure in chamber 72, of course, communicates the command signal from the TCM to the regulator valve 12B. The fluid in passage 84 is an optional signal from another operating device within the transmission, which will reduce the pressure in the transmission element 16B when desired.

As with the pressure regulator valve 12A, the regulator valve 12B issues a pressure control signal to a device within the transmission and the pressure issued thereby is directed through a pressure transducer back to the TCM so that regulation of the pressure in the transmission element 16B can be controlled within the parameters set by the TCM.

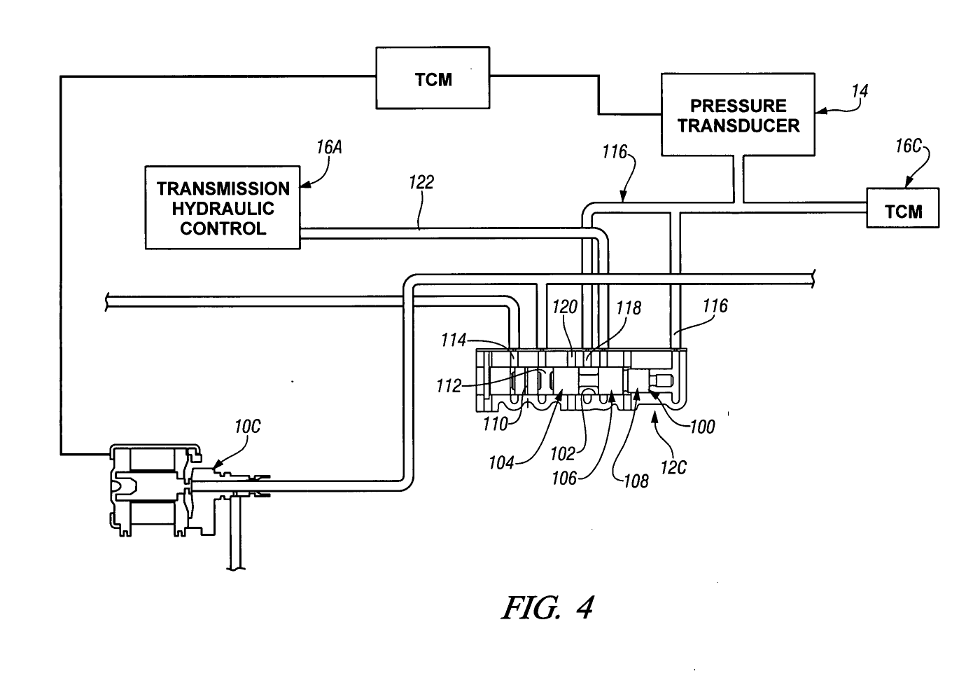

A torque converter regulator valve 12C is shown in FIG. 4. The regulator valve 12C includes a valve spool 100 slidably disposed in a valve bore 102. The valve spool 100 has three lands 104, 106, and 108. The regulator valve 12C also includes a plug or shuttle valve 110. The shuttle valve 110 operates within the valve bore 102 to provide two control chambers 112 and 114.

The control chamber 112 is in fluid communication with the solenoid valve 10C, which receives a control signal from the TCM. The chamber 114 receives a signal from a separate solenoid control valve, not shown, which supplies signals for purposes other than the regulation. The valve bore 102 communicates with a torque converter apply passage 116 at two ports 116 and 118, and a pressure supply passage 122, which is connected with the transmission element 16A to receive input pressure therefrom. The pressure in passage 122 is controlled by the regulation system shown in FIG. 2.

The valve bore 102 is also connected with an exhaust port 120, which will limit or return the excess fluid applied to the valve to the transmission sump. The fluid pressure in port 118 and passage 116 is supplied to a conventional transmission element such as a torque converter clutch 16C. The pressure in passage 116 is also directed to the pressure transducer 14 for controlling the signal issued back to the TCM to establish any change in pressure regulation as required by the transmission system. The pressure in passage 116 is also directed back to the valve bore 102 to operate on the right end of the regulator valve 12C to reduce the output pressure in accordance with the required signal from the TCM.

Those skilled in the art will now recognize that the type of pressure regulating systems shown in FIGS. 2, 3, and 4 are in accordance with the pressure regulation schedule described in FIG. 1. The regulation systems described in FIGS. 2, 3, and 4 represent the various pressure regulation system, clutch and brake systems, and torque converter clutch system within a transmission.

For example, FIG. 2 represents the conventional pressure regulation of a transmission control with improved electronic mechanisms and pressure mechanisms to provide closed-loop control for the pressure regulation. The system shown in FIG. 3 is a pressure used to control the engagement and disengagement of a conventional fluid-operated clutch and the regulation system shown in FIG. 4 is a control for a conventional torque converter clutch. In each of these systems, however, the closed-loop control of pressure as illustrated in FIG. 1 is incorporated. It is the closed-loop control described in FIG. 1 and employed in FIGS. 2, 3, and 4 that provide improved pressure regulation within the various transmission systems. It is precisely the closed-loop control, which establishes the desired control.

1. A pressure control system for a power transmission comprising:
a transmission control module;
a pilot valve means for receiving a signal from said transmission control module and issuing a pilot pressure signal;
a pressure regulator valve response means responsive to said pilot pressure for issuing a regulated pressure control signal to a predetermined load device;
a pressure transducer communicating with said regulated pressure signal and issuing an electronic signal commensurate with said regulated pressure signal to said transmission control module for utilization thereby to establish correction to said regulated pressure if required.

2. The pressure control system for a power transmission defined in claim 1 further comprising:
said predetermined load device being a torque carrying member torque-transmitting mechanism.

3. The pressure control system for a power transmission defined in claim 1 further comprising:
said predetermined load device being a torque carrying member torque converter clutch.

4. The pressure control system for a power transmission defined in claim 1 further comprising:
said predetermined load device being a main transmission pump and regulation system.

5. The pressure control system for a power transmission defined in claim 1 further comprising:
said predetermined load device being a pressure regulation mechanism.
